(19) United States
(12) Patent Application Publication
(10) Pub. No.: US 2018/0265697 A1
(43) Pub. Date: Sep. 20, 2018

(54) POLYMERIC MATERIALS

(71) Applicant: Victrex Manufacturing Limited, Lancashire (GB)

(72) Inventors: RICHARD AINSWORTH, Lancashire (GB); GEOFF SMALL, Lancashire (GB); DIANNE FLATH, Lancashire (GB); MICHAEL TOFT, Lancashire (GB)

(21) Appl. No.: 15/761,234

(22) PCT Filed: Sep. 16, 2016
(86) PCT No.: PCT/GB2016/052892

§ 371 Date: Mar. 19, 2018

(30) Foreign Application Priority Data
Sep. 18, 2015 (GB) 1516620.0
Jan. 25, 2016 (GB) 1601318.7

(51) Int. Cl. C08L 71/08; C08J 5/04; B32B 27/28

(52) U.S. Cl. CPC C08L 71/08; C08G 65/4012; B32B 27/285; C08J 5/043

(57) ABSTRACT

A composite material comprising: i) one or more polymeric material having a repeat unit of formula —O-Ph-O-Ph-CO-Ph- (I) wherein Ph represents a phenylene moiety; and ii) one or more glass fibre; wherein said one or more polymeric material has a melt viscosity (MV) of more than 0.15 kNsm⁻², but less than 0.65 kNsm⁻², measured according to Example 1; wherein said one or more polymeric material a Melt Flow Index (MFI) that falls within the range 51% to 151% of the MFI calculated using the equation: log₁₀(MFI)=1.929−2.408 (MV) wherein MV is the melt viscosity of said one or more polymeric material measured in kNsm⁻² and according to Example 1, and wherein MFI is measured in g/10 mins according to Example 2.

This invention relates to composite materials comprising polymeric materials and particularly, although not exclusively, composite materials for use in applications where the material is subjected to high temperature and high pressure for example in automotive or aerospace applications, and in oil and/or gas installations which additionally must deal with corrosive chemicals.

One of the most challenging environments in which a material may be used is underground in oil and gas production. In oil and/or gas production, materials may be subjected to high temperatures, high pressure and corrosive chemicals such as sour gas which is natural gas which includes significant amounts of hydrogen sulphide.

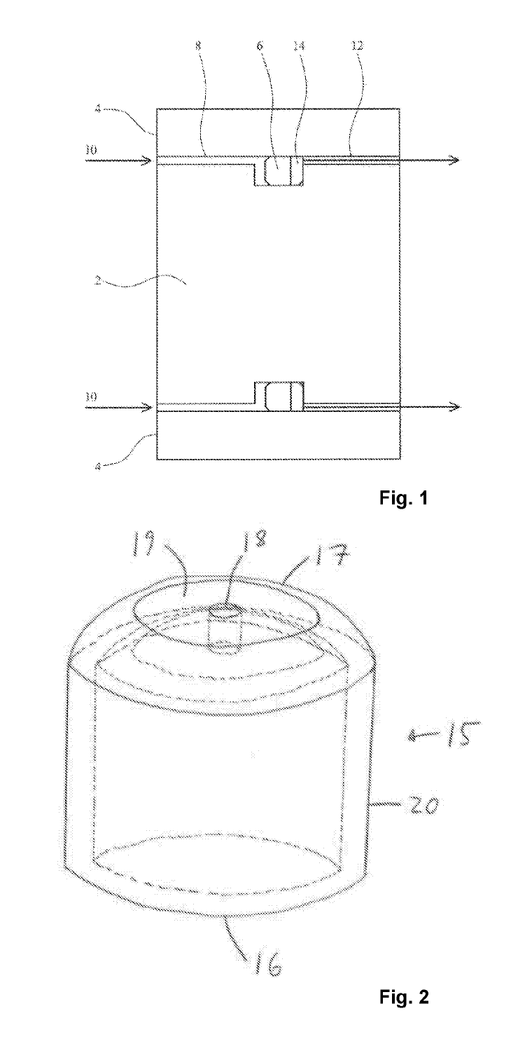

Often it is necessary to provide a seal between components which are part of an oil and gas installation. For example O-rings are often used in a valve where a seal is required between a valve shaft and valve housing. However, when O-rings are used in high pressure environments, the O-ring may have a tendency to extrude into the gap between the parts, resulting in failure of the seal. To address this problem, back-up rings (BURs) are used in conjunction with O-rings, as illustrated in FIG. 1. Such BURs may also be utilised in automotive or aerospace applications.

Referring to FIG. 1, there is shown a first circular cross-section part 2 within a second circular cross-section part 4. An elastomeric O-ring 6 is provided between the parts 2, 4 to seal the gap 8 therebetween. The parts 2, 4 are subjected to fluid pressure of for example up to 30,000 psi (207 Pa) (illustrated by arrows 10) and a temperature of about 260° C. and corrosive chemicals such as sour gas may be present. Under such conditions, there would be a tendency for seal 6 to extrude into gap 12 unless a BUR 14 was provided. BUR 14 may comprise an endless or split single turn ring or may comprise a spiral. It is arranged to prevent extrusion of O-ring 6. Additionally, the BUR itself needs to resist extrusion into gap 12, when subject to the extreme conditions referred to. The BUR may be split in order to allow it to be opened and placed over a shaft.

It is very challenging to select a polymeric material which is able to withstand the harsh conditions encountered in automotive or aerospace applications, and in oil and gas installations, for example subterranean installations. Polyaryletherketones (PAEKs) such as polyetheretherketone (PEEK) are high performance semi-crystalline polymers which may be used in automotive, aerospace, and oil and gas applications. In the manufacture of BURs, a composite material may be injection moulded into the shape of a tube called a billet. Once the molten composite material has cooled and solidified, the sprue (i.e. the excess material that defines the passage through which the molten composite material was introduced into a mould) is optionally cut out of the moulding to leave a finished billet 15 as shown in FIG. 2.

Billet 15 is open at a first end 16 and closed at a second end 17 except for a hole 18 in the centre of generally flat surface 19. Surface 19 lies perpendicular to cylindrical wall 20. Hole 18 is formed upon removal of the sprue. A moulded billet may be oven annealed to fully crystallize any polymer resin and to reduce moulded-in stresses. The billet is then used as a substrate from which precise geometry rings may be machined. A finished ring may then be scarf-cut (cut at an angle) or cut normal to the circumference of the ring to provide a split seal BUR.

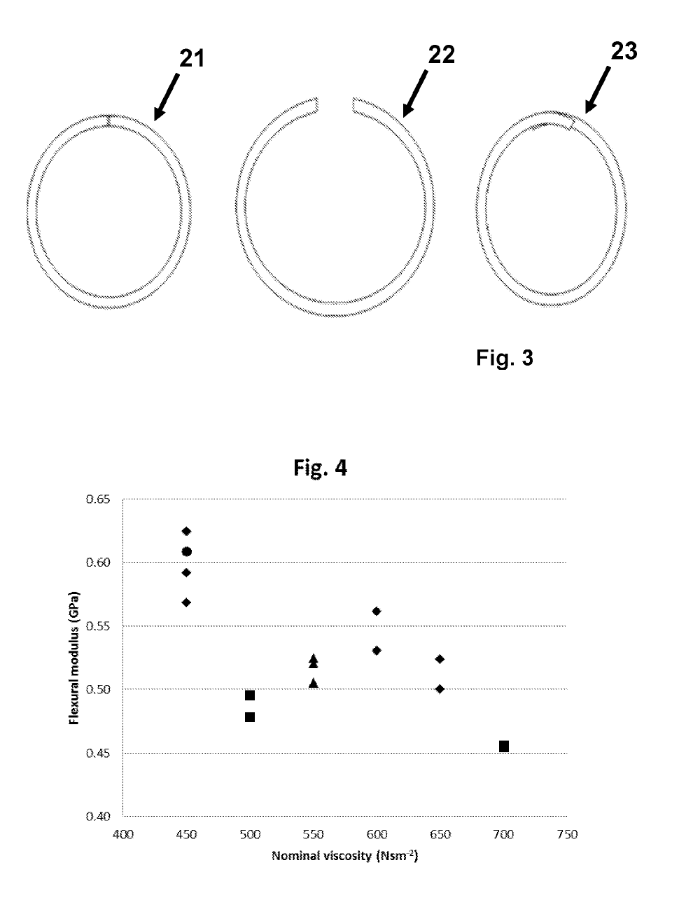

However, existing compositions comprising PEEK materials have disadvantages in the automotive, aerospace, and oil and gas fields, in particular in their application to split seal BURs. Some existing composite materials have advantageous high temperature mechanical properties, meaning that their performance in the application is superior to alternative materials. However, the processing of such composite materials, particularly when they are glass-filled, is problematic due to the presence of residual stress issues. This residual stress creates difficulties in machining split seal BURs to the required tolerances, e.g. the split seal BURs may deform, either with the cut ends pulling apart (they have “sprung out”), e.g. the ends may pull apart and remain in a plane of the circumference of the ring or may pull apart at an angle up to 90° to said plane, or pulling in past one another (they have “sprung in”), e.g. the ends may pull past one another at an angle up to 90° to said plane. These are both defects which are either cause for rejection or necessitate heat setting of the BURs. The defects are illustrated in FIG. 3 which shows three split seal BURs 21, 22, 23 wherein BUR 21 has not sprung and therefore retains the desired shape, BUR 22 has sprung out, and BUR 23 has sprung in. Furthermore, these residual stresses can also lead to breakages of the BURs upon installation at the end-user. Moreover, unpredictable variations in residual stress within moulded shapes can yield inconsistent products and result in excessive wastage post processing.

By contrast, these residual stress issues are somewhat overcome by alternative existing PEEK based composite materials, but to the disadvantage that BURs made from such composite materials have inferior high temperature mechanical properties, and hence have a shorter useful service life in application. Additionally, although the level of residual stress in such BURs may be lower, it can still be unacceptably unpredictable.

Accordingly there is a need for a composite material that has excellent high temperature mechanical properties and which can be readily processed to high dimensional tolerances.

According to a first aspect of the present invention there is provided a composite material comprising:

i) one or more polymeric material having a repeat unit of formula

—O-Ph-O-Ph-CO-Ph- I

wherein Ph represents a phenylene moiety; and

ii) one or more glass fibre;

wherein said one or more polymeric material has a melt viscosity (MV) of more than 0.15 kNsm⁻², but less than 0.65 kNsm⁻², measured according to Example 1;

wherein said one or more polymeric material has a Melt Flow Index (MFI) that falls within the range 51% to 151% of the MFI calculated using the equation:

log₁₀(MFI)=1.929−2.408(MV)

wherein MV is the melt viscosity of said one or more polymeric material measured in kNsm⁻² and according to Example 1, and wherein MFI is measured in g/10 mins according to Example 2.

It has surprisingly been found that the inventive composite material of the present invention provides exceptional high temperature mechanical properties and can be processed without an unacceptable occurrence of undesirable defects.

In the following discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

References herein such as “in the range x to y” are meant to include the interpretation “from x to y” and so include the values x and y.

Preferably said one or more polymeric material has an MFI that is at least 55% of the MFI calculated using said equation, more preferably at least 65%, even more preferably at least 75%, even more preferably at least 85%, even more preferably at least 95%. Preferably said one or more polymeric material has an MFI that is at most 145% of the MFI calculated using said equation, more preferably at most 135%, even more preferably at most 125%, even more preferably at most 115%, even more preferably at most 105%. In some preferred embodiments, said one or more polymeric material has an MFI that equals the MFI calculated using said equation.

Preferably the polymeric material has a Tc, measured as described herein in Example 4, of at least 265° C., more preferably at least 270° C., even more preferably at least 275° C., even more preferably at least 280° C., most preferably at least 285° C., but preferably at most 310° C., more preferably at most 305° C., more preferably at most 300° C., most preferably at most 295° C.

Preferably the polymeric material has a flexural modulus, measured in accordance with ISO178 (80 mm×10 mm×4 mm specimen, tested in three-point-bend at 175° C. at a rate of 2 mm/minute), of at least 0.45 GPa, more preferably at least 0.50 GPa, even more preferably at least 0.55 GPa, even more preferably at least 0.58 GPa, most preferably at least 0.60 GPa, but preferably at most 2 GPa, more preferably at most 1.5 GPa, more preferably at most 1.0 GPa, most preferably at most 0.75 GPa.

Preferably the composite material has a flexural modulus, measured in accordance with ISO178 (80 mm×10 mm×4 mm specimen, tested in three-point-bend at 175° C. at a rate of 2 mm/minute), of at least 2.0 GPa, more preferably at least 2.5 GPa, even more preferably at least 2.8 GPa, even more preferably at least 3.0 GPa, most preferably at least 3.2 GPa, but preferably at most 5.0 GPa, more preferably at most 4.5 GPa, more preferably at most 4.0 GPa, most preferably at most 3.6 GPa.

Said polymeric material may have a lightness (L*), measured as described herein, of at least 50, preferably at least 55, more preferably at least 60, most preferably at least 65, but preferably at most 80, more preferably at most 75, even more preferably at most 70. Colour measurements are carried out on standard type 1A ISO test bars (ISO 3167) that are injection moulded using said polymeric material on a Haitian injection moulding machine with a barrel temperature of 320° C.-335° C., nozzle temperature of 335° C. and a tool temperature of 160° C. The measurements should be made using a Konica Minolta Chromameter with a DP400 data processor operating over a spectral range of 360 nm to 750 nm. A white plate calibration is to be carried out with a D65 (natural daylight) light source. Colour measurements are expressed at L*, a* and b* coordinates as defined by the CIE 1976 (Nassau, K. Kirk-Othmer Encyclopaedia of Chemical Technology, chapter 7, page 303-341, 2004). Values are determined from a single point on the ISO test bar.

In some embodiments preferably the composite material comprises at least 50 wt % said polymeric material, more preferably at least 60 wt %, even more preferably at least 65 wt %, most preferably at least 68 wt %. In some embodiments preferably the composite material comprises at most 99 wt % said polymeric material, more preferably at most 95 wt %, more preferably at most 85 wt %, even more preferably at most 80 wt %, most preferably at most 75 wt %. These preferred values enable further improvements in the mechanical properties of the composite material.

Preferably the composite material comprises at least 1 wt % of said glass fibre, more preferably at least 5 wt % of said glass fibre, even more preferably at least 15 wt % of said glass fibre, even more preferably at least 25 wt % of said glass fibre, most preferably at least 28 wt % of said glass fibre, but preferably at most 60 wt % of said glass fibre, more preferably at most 50 wt % of said glass fibre, even more preferably at most 40 wt % of said glass fibre, even more preferably at most 35 wt % of said glass fibre, most preferably at most 32 wt % of said glass fibre. These preferred values enable further improvements in the mechanical properties of the composite material.

In some embodiments, the sum of the wt % of said polymeric material and said glass fibre preferably represents at least 90 wt %, more preferably at least 95 wt %, especially at least 99 wt % of said composite material. Thus, said composite material may consist essentially of said polymeric material and said glass fibre. In some preferred embodiments said composite material may consist of said polymeric material and said glass fibre.

The glass fibre may preferably comprise alumino-borosilicate glass. Alternatively said glass fibre may comprise alkali-lime glass, alumino-lime silicate glass, alkali-lime glass with high boron oxide content, borosilicate glass or alumino silicate glass. Said glass fibre preferably has a circular cross section, although in alternative embodiments the cross section may be oval, triangular, square, rectangular e.g. generally flat or another suitable shape. The glass fibre may have a cross sectional diameter of preferably at least 2 μm, more preferably at least 5 μm, even more at least 8 μm, most preferably at least 10 μm, but preferably at most 25 μm, more preferably at most 20 μm, even more preferably at most 15 μm, most preferably at most 13 μm.

The phenylene moieties (Ph) in repeat unit of formula I may independently have 1,4-para linkages to atoms to which they are bonded or 1,3-meta linkages. Where a phenylene moiety includes 1,3-linkages, the moiety will be in the amorphous phase of the polymer. Crystalline phases will include phenylene moieties with 1,4-linkages. In many applications it is preferred for the polymeric material to be highly crystalline and, accordingly, the polymeric material preferably includes high levels of phenylene moieties with 1,4-linkages.

In a preferred embodiment, at least 95%, preferably at least 99%, of the number of phenylene moieties (Ph) in the repeat unit of formula I have 1,4-linkages to moieties to which they are bonded. It is especially preferred that each phenylene moiety in the repeat unit of formula I has 1,4-linkages to moieties to which it is bonded.

Preferably, the phenylene moieties in repeat unit of formula I are unsubstituted. Said repeat unit of formula I suitably has the structure

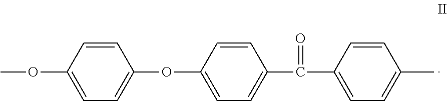

Said polymeric material suitably has a melt viscosity (MV) of more than 0.15 kNsm⁻², preferably at least 0.20 kNsm⁻², more preferably at least 0.25 kNsm⁻², even more preferably at least 0.35 kNsm⁻², most preferably at least 0.40 kNsm⁻², but preferably less than 0.65 kNsm⁻², more preferably at most 0.60 kNsm⁻², even more preferably at most 0.55 kNsm⁻², most preferably at most 0.50 kNsm⁻². MV refers to the melt viscosity measured as described in example 1.

The Tm of said polymeric material (suitably measured as described herein) may be less than 370° C., is suitably less than 360° C., is preferably less than 350° C. In some embodiments, the Tm may be less than 345° C. The Tm may be greater than 310° C., or greater than 320° C., 330° C. or 340° C. The Tm is preferably in the range 340° C. to 350° C.

The Tg of said polymeric material (suitably measured as described herein) may be greater than 130° C., preferably greater than 135° C., more preferably 140° C. or greater. The Tg may be less than 175° C., less than 165° C., less than 160° C. or less than 155° C. The Tg is preferably in the range 145° C. to 155° C.

The difference (Tm−Tg) between the Tm and Tg of said polymeric material may be at least 150° C., preferably at least 170° C., more preferably at least 190° C. The difference may be less than 230° C. or less than 210° C. In a preferred embodiment, the difference is in the range 195-205° C.

In a preferred embodiment, said polymeric material has a Tg in the range 145° C.-155° C., a Tm in the range 340° C. to 350° C. and the difference between the Tm and Tg is in the range 195° C. to 205° C.

Said composite material may have a crystallinity measured as described in Example 31 of WO2014207458A1 incorporated herein of at least 20%, preferably at least 22%, more preferably at least 24%. The crystallinity may be less than 30%.

Said composite material may have a tensile strength, measured in accordance with ISO527 (specimen type 1b) tested at 23° C. at a rate of 50 mm/minute of at least 150 MPa, of at least 160 MPa, preferably at least 165 MPa. The tensile strength is preferably in the range 165-180 MPa.

Said composite material may have a tensile modulus, measured in accordance with ISO527 (ISO527-1a test bar, tested in uniaxial tension at 23° C. at a rate of 1 mm/minute), of at least 10 GPa, preferably at least 10.5 GPa. The tensile modulus is preferably in the range 10.5-13.0 GPa.

Said composite material may have a flexural strength, measured in accordance with ISO178 (80 mm×10 mm×4 mm specimen, tested in three-point-bend at 23° C. at a rate of 2 mm/minute), of at least 250 MPa. The flexural strength is preferably in the range 250-290 MPa, more preferably in the range 255-280 MPa.

The composite material may have a Notched Izod Impact Strength (specimen 80 mm×10 mm×4 mm with a cut 0.25 mm notch (Type A), tested at 23° C., in accordance with ISO180) of at least 4 kJm⁻², preferably at least 5 kJm⁻², more preferably at least 10 kJm⁻², even more preferably at least 12 kJm⁻². The Notched Izod Impact Strength may be less than 40 kJm⁻², suitably less than 30 kJm⁻², more preferably less than 20 kJm⁻², most preferably less than 15 kJm⁻².

Said composite material may be provided in the form of pellets or granules. Said pellets or granules suitably comprise at least 90 wt %, preferably at least 95 wt %, especially at least 99 wt % of said composite material. Pellets or granules may have a maximum dimension of less than 10 mm, preferably less than 7.5 mm, more preferably less than 5.0 mm.

In some embodiments, said composite material may include a further filler. Said further filler may include a fibrous filler or a non-fibrous filler. Said further filler may include both a fibrous filler and a non-fibrous filler. A said fibrous filler may be continuous or discontinuous.

A said fibrous filler may be selected from inorganic fibrous materials, non-melting and high-melting organic fibrous materials, such as aramid fibres, and carbon fibre.

A said fibrous filler may be selected from carbon fibre, asbestos fibre, silica fibre, alumina fibre, zirconia fibre, boron nitride fibre, silicon nitride fibre, boron fibre, fluorocarbon resin fibre and potassium titanate fibre. A preferred fibrous filler is carbon fibre. A fibrous filler may comprise nanofibers.

A said non-fibrous filler may be selected from mica, silica, talc, alumina, kaolin, calcium sulfate, calcium carbonate, titanium oxide, ferrite, clay, glass powder, zinc oxide, nickel carbonate, iron oxide, quartz powder, magnesium carbonate, fluorocarbon resin, graphite, carbon powder, nanotubes and barium sulfate. The non-fibrous fillers may be introduced in the form of powder or flaky particles.

Preferably, said further filler comprises one or more fillers selected from carbon fibre, aramid fibres, carbon black and a fluorocarbon resin. More preferably, said further filler comprises carbon fibre.

A composite material as described may include at least 1 wt %, or at least 5 wt % of further filler. Said composite material may include 20 wt % or less or 10 wt % or less of further filler.

In some embodiments said composite material may preferably further comprise one or more antioxidants, such as a phenolic antioxidant (e.g. Octadecyl-3-(3,5-di-tert.butyl-4-hydroxyphenyl)-propionate), an organic phosphite antioxidant (e.g. tris(2,4-di-tert-butylphenyl)phosphite) and/or a secondary aromatic amine antioxidant.

In some embodiments, said composite material may include one or more of stabilizers such as light stabilizers and heat stabilizers, processing aids, pigments, UV absorbers, lubricants, plasticizers, flow modifiers, flame retardants, dyes, colourants, anti-static agents, extenders, metal deactivators, conductivity additives such as carbon black and carbon nanofibrils.

Said composite material may be prepared as described in Impregnation Techniques for Thermoplastic Matrix Composites. A Miller and A G Gibson, Polymer & Polymer Composites 4(7), 459-481 (1996), EP102158 and EP102159, the contents of which are incorporated herein by reference. Preferably, in the method, said polymeric material and said glass fibre (and optionally one or more further filler) are mixed at an elevated temperature, suitably at a temperature at or above the melting temperature of said polymeric material. Thus, suitably, said polymeric material and said glass fibre are mixed whilst the polymeric material is molten. Said elevated temperature is suitably below the decomposition temperature of the polymeric material. Said elevated temperature is preferably at or above the main peak of the melting endotherm (Tm) for said polymeric material. Said elevated temperature is preferably at least 300° C. Advantageously, the molten polymeric material can readily wet the glass fibre and/or penetrate consolidated fillers, such as fibrous mats or woven fabrics, so the composite material prepared comprises the polymeric material and glass fibre (and optionally one or more further filler) wherein said glass fibre and any further filler are substantially uniformly dispersed throughout the polymeric material.

The composite material may be prepared in a substantially continuous process. In this case the polymeric material and glass fibre (and optionally one or more further filler) may be constantly fed to a location wherein they are mixed and heated. An example of such a continuous process is extrusion. Another example, which is particularly relevant for fibrous fillers, involves causing a continuous filamentous mass to move through a melt or aqueous dispersion comprising said polymeric material. The continuous filamentous mass may comprise a continuous length of glass fibre and optionally further fibrous filler or, more preferably, a plurality of continuous filaments of glass fibre and optionally further fibrous filler which have been consolidated at least to some extent. The continuous fibrous mass may comprise a tow, roving, braid, woven fabric or unwoven fabric. The filaments which make up the fibrous mass may be arranged substantially uniformly or randomly within the mass. A composite material could be prepared as described in PCT/GB2003/001872, U.S. Pat. No. 6,372,294 or EP1215022.

Alternatively, the composite material may be prepared in a discontinuous process. In this case, a predetermined amount of said polymeric material and a predetermined amount of said glass fibre (and optionally one or more further filler) may be selected and contacted and a composite material prepared by causing the polymeric material to melt and causing the polymeric material and said glass fibre (and optionally one or more further filler) to mix to form a substantially uniform composite material.

Preferably said composite material is for use in automotive, aerospace, or oil and/or gas applications, such as oil and/or gas installations and/or apparatus for use in relation to oil and/gas installations.

The composite material may in some preferred embodiments be in the form of a tube and/or billet. Said billet may be a precursor to a back-up ring, preferably a split seal back-up ring.

According to a second aspect of the present invention there is provided a component which comprises a composite material according to the first aspect, wherein said component is arranged to guide the flow of a fluid, restrict the flow of a fluid, facilitate movement between two parts, facilitate support of one or more parts and/or facilitate connection of two or more parts, and/or is arranged to provide a precursor to any of the other components above.

Said composite material may have any feature of the composite material of the first aspect.

Preferably said component is for an automotive, aerospace, or oil and/or gas application, such as an oil and/or gas installation and/or apparatus for use in relation to oil and/gas installations. Said composite material of said component may be arranged to directly contact oil and/or gas associated with said installation in use.

A component which guides flow of a fluid may comprise a carrier for oil and/or gas such as a hose (e.g. a high pressure hose), a riser, a subsea umbilical or a sheath. Such a component may be a part of an internal surface of the carrier which is arranged to directly contact fluid being guided in use.

A component which restricts the flow of a fluid may comprise a seal, back-up ring or plug. A component which facilitates movement between two parts, facilitates support of one or more parts or facilitates connection of two or more parts may comprise bearings (e.g. protector thrust bearings), bushes, washers (e.g. thrust washers) or valve plates.

Said component may be selected from the following (which are preferably automotive, aerospace, or oil and gas applications, most preferably oil and gas applications): Seals, back-up rings, plugs and packers, motor winding slot liners, protector thrust bearings, motor pot heads, compressor vanes, bearings and bushes, thrust washers, valve plates and high pressure hoses, downhole sensors, marine risers, subsea umbilicals, hoses and/or sheaths. Said component is preferably a seal (e.g. an O-ring) or most preferably a back-up ring. Preferably said back-up ring is a split seal back-up ring.

Preferably the split seal back-up ring exhibits an average gap or overlap between its two ends of at most 15 mm, more preferably at most 10 mm, even more preferably at most 7 mm, even more preferably at most 5 mm, most preferably at most 4 mm. The gap or overlap is measured using a pair of Vernier calipers as described in Example 8.

A component that is arranged to provide a precursor to any of the other components above may comprise a tube and/or billet. Typically, the tube and/or billet has an outer diameter of at least 2.5 cm, preferably at least 5 cm, more preferably at least 8 cm, even more preferably at least 10 cm, but typically at most 40 cm, preferably at most 30 cm, more preferably at most 25 cm, even more preferably at most 21 cm. Typically, the tube and/or billet has a wall thickness of at least 0.2 cm, preferably at least 0.5 cm, more preferably at least 0.65 cm, even more preferably at least 1.0 cm, but typically at most 3 cm, preferably at most 2 cm, more preferably at most 1.5 cm, even more preferably at most 1.2 cm. Typically, the tube and/or billet has a length of at least 7 cm, preferably at least 9 cm, more preferably at least 10 cm, even more preferably at least 12 cm, but typically at most 25 cm, preferably at most 20 cm, more preferably at most 15 cm, even more preferably at most 13 cm.

According to a third aspect of the present invention there is provided an oil and/or gas installation or apparatus for use in relation to an oil and/or gas installation, said installation or apparatus comprising a component according to the second aspect.

Said component may have any feature of the component of the second aspect.

Suitably, said oil and/or gas installation and/or said apparatus is associated with both oil and gas, wherein said oil and gas comprises a naturally occurring hydrocarbon which is extracted from the ground. Hydrogen sulphide and/or sour gas may be present in or associated with the installation or apparatus, for example, so parts of the installation or apparatus (e.g. said component) may contact the hydrogen sulphide and/or sour gas in use.

Said apparatus for use in relation to an oil and/or gas installation may comprise apparatus which is temporarily or intermittently used in relation to an oil and/or gas installation. For example, such an apparatus may be arranged to be introduced into a subterranean formation with which an oil and/or gas installation is associated in order to carry out a task on or in relation to the formation or installation. For example, the apparatus may comprise a drilling installation or a pipe or tubing (e.g. coil tubing) arranged to be introduced into the formation.

Said oil and/or gas installation may be a production installation.

Said oil and/or gas installation may be arranged, at least partially, underground. Said oil and/or gas installation preferably comprises a subterranean installation (i.e. an installation arranged underground) which is optionally operatively connected to an installation above ground which may be associated with the transport of oil and/or gas. Said subterranean formation or said installation above ground may comprise said component. Preferably, said subterranean formation comprises said component.

Preferably, said installation or apparatus comprising said component is/are arranged underground.

Said third aspect preferably provides an oil and/or gas installation (rather than said apparatus for use in such an installation). Said component may be positioned so it is subjected to a temperature of greater than 100° C., greater than 150° C. or greater than 200° C. in use. It may be subjected to temperature of less than 350° C. or 300° C. in use.

Said component may be positioned so it is subjected to a pressure of greater than 40 MPa, 80 MPa, 120 MPa or 180 MPa. It may be subjected to a pressure of less than 300 MPa, less than 260 MPa or less than 220 MPa.

Said component may be positioned so it contacts gas, for example hydrogen sulphide-containing gas in use.

Said component may, at the same time, be subjected to at least two (preferably all three) of the following: a temperature as described (e.g. in the range 150° C. to 350° C.), a pressure as described (e.g. in the range 40 MPa to 300 MPa), and a gas, for example an acidic gas such as containing hydrogen sulphide.

According to a fourth aspect of the present invention there is provided process for manufacturing a component according to the second aspect, the process comprising, in sequence:

a) selecting a composite material according to the first aspect; and

b) forming said component via injection moulding, compression moulding and/or extruding said composite material.

Preferably step b) comprises forming said component via injection moulding. Preferably said component is a tube and/or billet.

Said injection moulding may preferably be performed at an injection pressure and/or at a hold pressure of at least 800 bar, more preferably at least 1000 bar, even more preferably at least 1150 bar, but preferably at most 2000 bar, more preferably at most 1500 bar, even more preferably at most 1250 bar. Said injection moulding may preferably be performed with an injection time of at least 2 s, more preferably at least 7 s, even more preferably at least 11 s, but preferably at most 25 s, more preferably at most 18 s, even more preferably at most 13 s. Said injection moulding may preferably be performed with a hold time of at least 20 s, more preferably at least 40 s, even more preferably at least 50 s, but preferably at most 200 s, more preferably at most 120 s, even more preferably at most 70 s. Said injection moulding may preferably be performed with a cooling time of at least 60 s, more preferably at least 120 s, even more preferably at least 170 s, but preferably at most 400 s, more preferably at most 250 s, even more preferably at most 190 s. Said injection moulding may preferably be performed with a cycle time of at least 180 s, more preferably at least 250 s, even more preferably at least 290 s, but preferably at most 600 s, more preferably at most 400 s, even more preferably at most 310 s. Said injection moulding may preferably be performed with a barrel temperature (i.e. a barrel that contains the composite material) of at least 250° C., more preferably at least 320° C., even more preferably at least 375° C., but preferably at most 500° C., more preferably at most 430° C., even more preferably at most 395° C. Said injection moulding may preferably be performed with a mould temperature of at least 100° C., more preferably at least 150° C., even more preferably at least 180° C., but preferably at most 350° C., more preferably at most 250° C., even more preferably at most 200° C. Said injection moulding may preferably be performed with a change over position of at least 5 mm, more preferably at least 15 mm, even more preferably at least 18 mm, but preferably at most 40 mm, more preferably at most 30 mm, even more preferably at most 22 mm. Said injection moulding may preferably be performed with a cushion size of at least 5 mm, more preferably at least 10 mm, even more preferably at least 15 mm, but preferably at most 30 mm, more preferably at most 20 mm, even more preferably at most 17 mm.

Preferably the compression moulding is performed by packing a compression moulding tool with the composite material at a pressure of at least 250 bar, more preferably at least 310 bar, even more preferably at least 340 bar, but preferably at most 500 bar, more preferably at most 400 bar, even more preferably at most 360 bar. Preferably said tool is then placed between platens and the tool and platens are heated such that the composite material achieves a temperature of at least 300° C., more preferably at least 360° C., even more preferably at least 390° C., but preferably at most 500° C., more preferably at most 440° C., even more preferably at most 410° C. Preferably the composite material is heated at a pressure of at least 10 bar, more preferably at least 15 bar, even more preferably at least 18 bar, but preferably at most 35 bar, more preferably at most 25 bar, even more preferably at most 22 bar. Preferably the composite material is then cooled to a temperature of from 300° C. to 380° C., more preferably 320° C. to 360° C., even more preferably 335° C. to 350° C. When said composite material has cooled to the desired temperature, the composite material is preferably subjected to a pressure of at least 80 bar, more preferably at least 110 bar, even more preferably at least 130 bar, but preferably at most 200 bar, more preferably at most 170 bar, even more preferably at most 150 bar. Preferably the composite material is then cooled to a temperature of from 150° C. to 250° C., more preferably 180° C. to 220° C., even more preferably 190° C. to 210° C., which preferably occurs at a rate of from 0.1 to 1.0° C./min, more preferably 0.3 to 0.7° C./min, even more preferably 0.4 to 0.6° C./min. Preferably the component is then removed from the tool without any further cooling.

The process may further comprise, after step b):

c) annealing said component.

Step c) may comprise heating the component (from a temperature of 20° C.) to a temperature of at least 150° C., more preferably at least 200° C., even more preferably at least 215° C., but preferably at most 350° C., more preferably at most 250° C., even more preferably at most 225° C. The component may be raised to said temperature over at least 2 hr, more preferably at least 4 hr, even more preferably at least 5 hr, but preferably at most 10 hr, more preferably at most 7 hr, even more preferably at most 6 hr. The component may be maintained at said temperature for at least 1 hr, more preferably at least 3 hr, even more preferably at least 4 hr, but preferably at most 10 hr, more preferably at most 6 hr, even more preferably at most 5 hr. The component may be cooled to a temperature of 20° C. over at least 10 hr, more preferably at least 15 hr, even more preferably at least 20 hr, but preferably at most 40 hr, more preferably at most 30 hr, even more preferably at most 22 hr.

When the component is a tube and/or billet, components such as one or more seal, back-up ring, bushing, and/or washer may suitably be manufactured by further processing said tube and/or billet. For example, said tube and/or billet may be cut or otherwise machined to provide one or more of said components. Said cutting may be performed using a lathe.

Said one or more component provided by further processing said tube and/or billet may be cut to provide one or more split component, preferably one or more split seal back-up ring. Said cutting may comprise scarf-cutting or cutting normal to a circumference of said component.

According to a fifth aspect of the present invention there is provided the use of a composite material according to the first aspect in the manufacture of a component to increase the flexural modulus, measured in accordance with ISO178 (80 mm×10 mm×4 mm specimen, tested in three-point-bend at 175° C. at a rate of 2 mm/minute), of said component.

According to a sixth aspect of the present invention there is provided the use of a composite material according to the first aspect in the manufacture of a component to provide a flexural modulus of said component, measured in accordance with ISO178 (80 mm×10 mm×4 mm specimen, tested in three-point-bend at 175° C. at a rate of 2 mm/minute), of at least 3.0 GPa.

According to a seventh aspect of the present invention there is provided the use of a composite material according to the first aspect in the manufacture of a split seal back-up ring to reduce the spring of a split seal back-up ring wherein the spring of said split seal back-up ring is determined by measuring an average gap or overlap as described in Example 8.

The spring of a split seal back-up ring may be determined by measuring an average gap or overlap between its two ends using Vernier calipers. The lower the spring, the lower the average gap or overlap.

According to an eighth aspect of the present invention there is provided the use of a composite material according to the first aspect in the manufacture of a split seal back-up ring to provide a maximum average gap or overlap of 4 mm between the two ends of said split seal back-up ring.

According to an ninth aspect of the present invention there is provided the use of the composite material according to the first aspect or the component according to the second aspect in automotive, aerospace, medical, electronic, oil and/or gas applications.

According to an tenth aspect of the present invention there is provided the use of a component which comprises a composite material or an apparatus comprising said component in an oil and/or gas installation, wherein said composite material, component, apparatus, and/or oil and/or gas installation are as described in any preceding aspect.

According to a eleventh aspect of the present invention there is provided the use of the composite material according to the first aspect in the manufacture of a compression moulded component to provide a Notched Izod Impact Strength (specimen 80 mm×10 mm×4 mm with a cut 0.25 mm notch (Type A), tested at 23° C., in accordance with ISO180) of said component of at least 12.5 kJm⁻² and a flexural modulus of said component, measured in accordance with ISO178 (80 mm×10 mm×4 mm specimen, tested in three-point-bend at 175° C. at a rate of 2 mm/minute), of at least 3.0 GPa.

According to a twelfth aspect of the present invention there is provided a composite material comprising:

i) one or more polymeric material having a repeat unit of formula

—O-Ph-O-Ph-CO-Ph- I

wherein Ph represents a phenylene moiety; and

ii) one or more glass fibre;

wherein said one or more polymeric material has a melt viscosity (MV) of more than 0.15 kNsm⁻², but less than 0.65 kNsm⁻², measured according to Example 1;

wherein MV is the melt viscosity of said one or more polymeric material measured in kNsm⁻² and according to Example 1; and

wherein the composite material is in the form of a tube and/or billet, or a back-up ring, preferably a split seal back-up ring.

According to a thirteenth aspect of the present invention there is provided a component which comprises a composite material comprising:

i) one or more polymeric material having a repeat unit of formula

—O-Ph-O-Ph-CO-Ph- I

wherein Ph represents a phenylene moiety; and

ii) one or more glass fibre;

wherein said one or more polymeric material has a melt viscosity (MV) of more than 0.15 kNsm⁻², but less than 0.65 kNsm⁻², measured according to Example 1;

wherein MV is the melt viscosity of said one or more polymeric material measured in kNsm⁻² and according to Example 1; and

wherein said component is arranged to guide the flow of a fluid, restrict the flow of a fluid, facilitate movement between two parts, facilitate support of one or more parts and/or facilitate connection of two or more parts, and/or is arranged to provide a precursor to any of the other components above.

Said component according to the thirteenth aspect may be selected from the following (which are preferably automotive, aerospace, or oil and gas applications, most preferably oil and gas applications): Seals, back-up rings, plugs and packers, motor winding slot liners, protector thrust bearings, motor pot heads, compressor vanes, bearings and bushes, thrust washers, valve plates and high pressure hoses, downhole sensors, marine risers, subsea umbilicals, hoses, sheaths, tubes and/or billets. Said component is preferably a seal (e.g. an O-ring) or most preferably a back-up ring or a tube and/or billet. Preferably said back-up ring is a split seal back-up ring.

Said component according to the thirteenth aspect that is arranged to provide a precursor to any of the other components above may comprise a tube and/or billet.

Said composite material of the twelfth aspect may have any feature of the composite material of the first aspect. Said component of the thirteenth aspect may have any feature of the component of the second aspect.

According to a fourteenth aspect of the present invention there is provided a tube and/or billet comprising a hollow cylinder having at least one closed end,

wherein said hollow cylinder comprises a composite material according to the first or twelfth aspect, and

wherein an edge between an external surface of said closed end and an external lateral surface of said cylinder comprises at least one curved portion.

It has surprisingly been determined that a tube and/or billet according to the fourteenth aspect helps to minimise residual stresses within the tube and/or billet. It is understood that this effect is achieved because the edge comprising at least one curved portion assists with polymer flow. The reduction of residual stresses is desirable because such stresses can cause components to fail prematurely.

Preferably said at least one curved portion at least partially extends around a circumference of said edge. Preferably said at least one curved portion completely extends around a circumference of said edge.

Said external surface of said at least one closed end of said hollow cylinder is preferably substantially flat, more preferably completely flat.

In the context of the present invention, the Glass Transition Temperature (Tg), the Cold Crystallisation Temperature (Tn), the Melting Temperature (Tm) and Heat of Fusions of Nucleation (ΔHn) and Melting (ΔHm) are determined using the following DSC method:

A dried sample of a polymer is compression moulded into an amorphous film, by heating 7 g of polymer in a mould at 400° C. under a pressure of 50 bar for 2 minutes, then quenching in cold water producing a film of dimensions 120×120 mm, with a thickness in the region of 0.20 mm. An 8 mg plus or minus 3 mg sample of each film is scanned by DSC as follows:
Step 1 Perform and record a preliminary thermal cycle by heating the sample from 30° C. to 400° C. at 20° C./min.
Step 2 Hold for 5 minutes.
Step 3 Cool at 20° C./min to 30° C. and hold for 5 mins.
Step 4 Re-heat from 30° C. to 400° C. at 20° C./min, recording the Tg, Tn, Tm, ΔHn and ΔHm.

From the DSC trace resulting from the scan in step 4, the onset of the Tg is obtained as the intersection of the lines drawn along the pre-transition baseline and a line drawn along the greatest slope obtained during the transition. The Tn is the temperature at which the main peak of the cold crystallisation exotherm reaches a maximum. The Tm is the temperature at which the main peak of the melting endotherm reaches a maximum.

The Heats of Fusion for Nucleation (ΔHn) and Melting (ΔHm) are obtained by connecting the two points at which the cold crystallisation and melting endotherm(s) deviate from the relatively straight baseline. The integrated areas under the endotherms as a function of time yield the enthalpy (mJ) of the particular transition, the mass normalised Heats of Fusion are calculated by dividing the enthalpy by the mass of the specimen (J/g).

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

Specific embodiments of the invention will now be described, by way of example, and with reference to the accompanying figures in which:

FIG. 1 is a cross-section through an apparatus in accordance with the present invention comprising a valve stem and valve housing;

FIG. 2 is a perspective view, in which hidden aspects are shown as broken lines, of a billet in accordance with the present invention;

FIG. 3 is a schematic view of a split seal back-up ring in accordance with the present invention and two prior art split seal back-up rings; and

FIG. 4 is a graph showing flexural modulus vs. nominal viscosity for several commercially available polymers and a polymer utilised in the present invention.

FIG. 1 shows a valve stem and valve housing and is discussed in detail above in page 1.

The BUR 14 illustrated is in accordance with the present invention.

FIG. 2 shows a billet in accordance with the present invention and is discussed in detail above in pages 1-2.

FIG. 3 shows a split seal BUR 21 in accordance with the present invention and two prior art BURs 22, 23, and is discussed in detail above in page 2.

### EXAMPLE 1

### Melt Viscosity of Polymers

The Melt Viscosity of polymers was measured using a ram extruder fitted with a tungsten carbide die, 0.5 mm (capillary diameter)×3.175 mm (capillary length). Approximately 5 grams of the polyaryletherketone was dried in an air circulating oven for 3 hours at 150° C. The extruder was allowed to equilibrate to 400° C. The dried polymer was loaded into the heated barrel of the extruder, a brass tip (12 mm long×9.92±0.01 mm diameter) placed on top of the polymer followed by the piston and the screw was manually turned until the proof ring of the pressure gauge just engages the piston to help remove any trapped air. The column of polymer was allowed to heat and melt over a period of at least 5 minutes. After the preheat stage the screw was set in motion so that the melted polymer was extruded through the die to form a thin fibre at a shear rate of 1000 s⁻¹, while recording the pressure (P) required to extrude the polymer. The Melt Viscosity is given by the formula

$$Melt Viscosity = \frac{P π {r}^{4}}{8 LSA} {kNsm}^{- 2}$$

where P=Pressure/kN m⁻²
L=Length of die/m
S=ram speed/m s⁻¹
A=barrel cross-sectional area/m²
r=Die radius/m
The relationship between shear rate and the other parameters is given by the equation:

$$Apparent wall shear rate = 1000 {s}^{- 1} = \frac{4 Q}{π {r}^{3}}$$

where Q=volumetric flow rate/m³s⁻¹=SA.

### EXAMPLE 2

### Melt Flow Index of Polymers

The Melt Flow Index of polymers was measured on a CEAST Melt Flow Tester 6941.000. The dry polymer was placed in the barrel of the Melt Flow Tester apparatus and heated to 400° C., this temperature being selected to fully melt the polymer. The polymer was then extruded under a constant shear stress by inserting a weighted piston (2.16 kg) into the barrel and extruding through a tungsten carbide die, 2.095 mmbore×8.000 mm. The MFI (Melt Flow Index) is the mass of polymer (in g) extruded in 10 minutes.

### EXAMPLE 3

### Preparation of Polyetheretherketone

A 70 litre stainless steel reactor fitted with a lid, stirrer/stirrer guide, nitrogen inlet and outlet was charged with diphenylsulphone (DPS) (17.3 kg) and heated to 160° C. Once the diphenylsulfone had fully melted, hydroquinone (HQ) (3.85 kg, 35.00 mol) and 4,4′-difluorobenzophenone (BDF) (99.97% w/w purity by HPLC-UV, 7.75 kg, 35.56 mol) were charged to the reactor under nitrogen. Dried sodium carbonate (3.73 kg, 35.18 mol) sieved through a screen with a mesh of 500 μm and potassium carbonate (0.097 kg, 0.70 mol) was added. The contents were then heated to 180° C. at 1° C./min while maintaining a nitrogen blanket and held for 100 minutes. The temperature was then raised to 200° C. at 1° C./min and held for 20 minutes. The temperature was further raised to 315° C. at 1° C./min and held until the desired molecular weight was reached as determined by the torque rise of the stirrer. The required torque rise was determined from a calibration graph of torque rise versus Melt Viscosity (MV). The reaction mixture was poured via a band caster into a water bath, allowed to cool, milled and washed with 400 litres of acetone and 1000 litres of water. The resulting polymer powder was dried in a tumble dryer until the contents temperature measured 110° C. The resulting polymer had an MV of 0.45 kNsm⁻² measured as described in Example 1. Example 3 was repeated to obtain polymers with MVs of 0.42 kNsm⁻², 0.56 kNsm⁻² and 0.575 kNsm⁻².

### EXAMPLE 4

### Measurement of Tc by DSC

The crystallisation temperature from the melt (Tc) for selected PEEK polymers was determined by Differential Scanning calorimetry.

A dried sample of each polymer was compression moulded into an amorphous film, by heating 7 g of polymer in a mould at 400° C. under a pressure of 50 bar for 2 minutes, then quenching in cold water producing a film of dimensions 120×120 mm, with a thickness in the region of 0.20 mm. An 8 mg plus or minus 3 mg sample of each film was scanned as follows:

Step 1 Perform a preliminary thermal cycle by heating the sample from 30° C. to 400° C. at 20° C./min.

Step 2 Hold for 2 mins.

Step 3 Cool at 20° C./min to 30° C. and hold for 5 mins.

Step 4 Heat from 30° C. to 400° C. at 20° C./mins.

From the resulting scan the Tc was the temperature at which the main peak of the crystallisation from the melt reached a maximum.

### EXAMPLE 5

### Preparation of Composite Material

Four composite materials were prepared in substantially continuous processes using the polymers with MVs of 0.42 kNsm⁻², 0.45 kNsm⁻², 0.56 kNsm⁻², and 0.575 kNsm⁻² that were prepared in Example 3. For each of the four polymers, 70% wt of the polymer and 30% wt of glass fibre (circular cross section, diameter 10-13 μm, E-glass) were gradually and simultaneously fed into a twin screw extruder wherein they were mixed, heated and extruded to form the composite material.

### EXAMPLE 6

### Preparation of Billet

Two billets with an outer diameter of 20.3 cm and a wall thickness of 11 mm were prepared by injection moulding 1560 g each of the two composite materials prepared using polymers with MVs of 0.42 kNsm⁻² and 0.56 kNsm⁻² according to example 5 using a 380T injection moulder.

The below mould parameters were employed:

Injection Pressure: 1200 bars

Injection Time: 12 s

Hold Pressure: 1200 bars

Hold Time: 60 s

Cooling Time/Cycle Time: 180 s, 300 s

Barrel/Mould Temperatures: 385° C./190° C.

Change Over position: 20 mm

Cushion Size: 16 mm, yes

The sprues were then removed using a digital lathe to yield billets which were then annealed under the following conditions:

The billet was placed in an oven and the temperature of the oven was raised from 20° C. to 175° C. over 30 mins. The oven temperature was then raised from 175° C. to 220° C., at a rate of 10° C./hour. When the oven temperature reached 220° C., this temp was maintained for 4 hours. The oven temperature was then cooled at a rate of 10° C./hour until it reached 20° C.

### EXAMPLE 7

### Preparation of Split Seal Back-Up Rings

The billets prepared in example 6 were cut with a digital lathe to provide split seal BURs with a thickness of 3 mm. Comparative split seal BURs with the same dimensions were similarly prepared using Victrex® PEEK 450GL30 STD and Solvay® Ketaspire® KT820GF30 commercially available billets. Corresponding split seal BURs were also prepared from billets analogous to those prepared in example 6 but which had not been annealed.

### EXAMPLE 8

### Gap/Overlap Testing of Split Seal BURs

Split seal BURs prepared in example 7 from polymers prepared in example 3 with MVs of 0.42 kNsm⁻² and 0.56 kNsm⁻² were tested alongside split seal BURs prepared in example 7 from Victrex® PEEK 450GL30 STD and Solvay® Ketaspire® KT820GF30 billets.

The testing was carried out by measuring the gap or overlap between the two ends of each split seal BUR using Vernier calipers by measuring the distance between a central point of a surface of one end and a central point of a surface of the other end.

The results are shown below in Table 1:

TABLE 1
Gap/Overlap testing of two split seal BURs according to
the present invention and two prior art split seal BURs

| Type of billet used | Solvay (RTM) | Example 6 | Example 6 | Victrex (RTM) |
|---|---|---|---|---|
| to prepare split | Ketaspire (RTM) | 0.42 kNsm⁻² | 0.56 kNsm⁻² | PEEK 450GL30 |
| seal BUR | KT820GF30 | MV polymer | MV polymer | STD |
| | Before Annealing | | | |
| Average Gap (mm) | −15.93 | −16.75 | −16.82 | −12.86 |
| Standard Deviation | 2.55 | 2.75 | 2.71 | 6.10 |
| (mm) | | | | |
| | After Annealing | | | |
| Average Gap (mm) | 3.86 | 2.86 | 3.89 | 8.82 |
| Standard Deviation | 2.36 | 3.11 | 3.25 | 8.22 |
| (mm) | | | | |

Table 1 shows that the two BURs according to the present invention exhibit similar average gaps and standard deviations to the BUR prepared from a Solvay® billet, both before and after annealing. Furthermore, the two BURs according to the present invention exhibit far smaller standard deviations than the BUR prepared from a Victrex® billet, both before and after annealing, whilst the average gap of both of said two BURs after annealing is smaller than the average gap of the BUR prepared from a Victrex® billet.

### EXAMPLE 9

### Flexural Modulus Testing of Polymer and Composite Material

The flexural modulus of the polymer with an MV of 0.45 kNsm⁻² prepared in example 3 and several commercially available polymers was tested in accordance with ISO178 (80 mm×10 mm×4 mm specimen, tested in three-point-bend at 175° C. at a rate of 2 mm/minute. For this purpose, standard type 1A ISO test bars (ISO 3167) were injection moulded using each of the polymers on a Haitian injection moulding machine with a barrel temperature of 320° C.-335° C., nozzle temperature of 335° C. and a tool temperature of 160° C.

The results are illustrated in FIG. 4 which shows flexural modulus vs. nominal viscosity for these polymers. The data is also shown in Table 2 below:

TABLE 2
Flexural modulus and nominal viscosity for
several commercially available polymers and
a polymer utilised in the present invention

| | Nominal | Flexural |
|---|---|---|
| | Viscosity | Modulus |
| Polymer | (Nsm⁻²) | (GPa) |
| Polymer prepared in Example 3 | 450 | 0.61 |
| Victrex (RTM) PEEK 450G | 450 | 0.57 |
| Victrex (RTM) PEEK 450G | 450 | 0.62 |
| Victrex (RTM) PEEK 450P | 450 | 0.59 |
| Victrex (RTM) PEEK 650G | 650 | 0.50 |
| Victrex (RTM) PEEK 650G | 650 | 0.52 |
| Victrex (RTM) PEEK 600G | 600 | 0.56 |
| Victrex (RTM) PEEK 600P | 600 | 0.53 |
| Evonik (RTM) Vestakeep PEEK L4000G | 500 | 0.48 |
| Evonik (RTM) Vestakeep PEEK L4000G | 500 | 0.50 |
| Evonik (RTM) Vestakeep PEEK 5000G | 700 | 0.46 |
| Evonik (RTM) Vestakeep PEEK 5000G | 700 | 0.45 |
| Solvay (RTM) Ketaspire KT820NT | 550 | 0.52 |
| Solvay (RTM) Ketaspire KT820NT | 550 | 0.52 |
| Solvay (RTM) Ketaspire KT851NT | 550 | 0.51 |

In FIG. 4 the polymer prepared in Example 3 is represented by a circle, the Victrex® polymers are represented by diamonds, the Evonik® polymers are represented by squares, and the Solvay® polymers are represented by triangles.

FIG. 4 shows that the polymer utilised in the present invention exhibits a flexural modulus that is at least equal to the very best of the tested commercially available polymers. Accordingly, the composite material of the present invention is enables the formation of components that have both superior high temperature mechanical properties and excellent dimensional tolerances.

The flexural modulus of the composite material prepared in example 5 using the polymer with an MV of 0.45 kNsm⁻² was similarly tested (using the composite material instead of the polymer) alongside the commercially available composite material Victrex® PEEK 450GL30 STD (containing polymer with an MV of 0.45 kNsm⁻²). The results are shown in Table 3 below:

TABLE 3
Flexural modulus for a composite material according to the
present invention and Victrex (RTM) PEEK 450GL30 STD

| | Flexural Modulus |
|---|---|
| Type of Composite Material | (GPa) |
| Victrex (RTM) PEEK 450GL30 STD | 3.6 |
| From Example 5 prepared using the | 3.3 |
| polymer with an MV of 0.45 kNsm⁻² | |

Table 3 shows that the composite material of the present invention exhibits a flexural modulus that is comparable to the superior commercially available composite materials.

### EXAMPLE 10

### MFI Results

Following the method set out in Example 2, the MFIs of the polymers with an MV of 0.45 kNsm⁻² and 0.575 kNsm⁻² prepared in example 3, and the commercially available polymer Victrex® PEEK 450G (MV of 0.45 kNsm⁻²) were tested and the results are shown below in Table 4:

TABLE 4
MFI for two polymers utilised in the present
invention and for Victrex (RTM) PEEK 450G

| | MFI |
|---|---|
| Type of Polymer | (g/10 mins) |
| Polymer with an MV of 0.45 kNsm⁻² | 7.0 |
| prepared in Example 3 | |
| Polymer with an MV of 0.575 kNsm⁻² | 3.5 |
| prepared in Example 3 | |
| Victrex (RTM) PEEK 450G | 3.3 |

Table 4 shows that, for a given MV, the MFI of the polymer utilised in the present invention is higher than that of the commercially available polymer. Furthermore, the MV and MFI of the polymer utilised in the present invention follow the relationship:

log₁₀(MFI)=1.929−2.408(MV)

wherein MV is the melt viscosity of said one or more polymeric material measured in kNsm⁻² and according to Example 1, and wherein MFI is measured in g/10 mins according to Example 2.

Surprisingly, as shown above, it has been found that composite materials prepared from such polymers that follow this MV-MFI relationship provide both high temperature mechanical properties and can be processed with ease to provide components with high dimensional tolerances.

### EXAMPLE 11

### Notched Izod Impact Strength Testing

The Notched Izod Impact Strength (specimen 80 mm×10 mm×4 mm with a cut 0.25 mm notch (Type A), tested at 23° C., in accordance with ISO180) of the composite materials prepared in Example 5 using polymers with an MV of 0.45 kNsm⁻² and 0.575 kNsm⁻² prepared in example 3, and the commercially available composite material Victrex® PEEK 450GL30 STD (containing a polymer with an MV of 0.45 kNsm⁻²) were tested and the results are shown below in Table 5:

TABLE 5
Notched Izod Impact Strength for two composite
materials according to the present invention
and for Victrex (RTM) PEEK 450GL30 STD

| | Notched Izod |
|---|---|
| | Impact Strength |
| Type of Composite Material | (kJ/m²) |
| Polymer with an MV of 0.45 kNsm⁻² | 13.2 |
| prepared in Example 3 | |
| Polymer with an MV of 0.575 kNsm⁻² | 13.2 |
| prepared in Example 3 | |
| Victrex (RTM) PEEK 450GL30 STD | 12.4 |

Table 5 illustrates that the composite materials according to the present invention are slightly tougher than the commercially available composite material, which translates to analogous advantages for components comprising such composite materials.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1. A composite material comprising:
i) one or more polymeric material having a repeat unit of formula
—O-Ph-O-Ph-CO-Ph- I
wherein Ph represents a phenylene moiety; and
ii) one or more glass fibre;
wherein said one or more polymeric material has a melt viscosity (MV) of more than 0.15 kNsm⁻², but less than 0.65 kNsm⁻², measured according to Example 1;
wherein said one or more polymeric material has a Melt Flow Index (MFI) that falls within the range 51% to 151% of the MFI calculated using the equation:
log₁₀(MFI)=1.929−2.408(MV)
wherein MV is the melt viscosity of said one or more polymeric material measured in kNsm⁻² and according to Example 1, and wherein MFI is measured in g/10 mins according to Example 2.

2-25. (canceled)

26. The composite material according to claim 1, wherein said one or more polymeric material has at least one of the following features:
(i) an MFI that is at least 55%, preferably at least 65% of the MFI calculated using said equation, but at most 145%, preferably at most 135% of the MFI calculated using said equation;
(ii) a flexural modulus, measured in accordance with ISO178 (80 mm×10 mm×4 mm specimen, tested in three-point-bend at 175° C. at a rate of 2 mm/minute), of at least 0.45 GPa, and/or wherein the composite material has a flexural modulus, measured in accordance with ISO178 (80 mm×10 mm×4 mm specimen, tested in three-point-bend at 175° C. at a rate of 2 mm/minute), of at least 3.0 GPa; and
(iii) has a lightness (L*), measured as described herein, of at least 60, but at most 75; and
(iv) has a melt viscosity (MV) of more than 0.20 kNsm⁻², but less than 0.60 kNsm⁻², measured according to Example 1.

27. The composite material according to claim 26, wherein the composite material comprises at least 25 wt % of said glass fibre, but at most 50 wt % of said glass fibre.

28. The composite material according to claim 27, wherein said composite material is for use in automotive, aerospace, or oil and/or gas applications, such as oil and/or gas installations and/or apparatus for use in relation to oil and/gas installations.

29. A component which comprises a composite material according to claim 1, wherein said component is arranged to guide the flow of a fluid, restrict the flow of a fluid, facilitate movement between two parts, facilitate support of one or more parts and/or facilitate connection of two or more parts, and/or is arranged to provide a precursor to any of the other components above.

30. The component according to claim 29, wherein said component is selected from the following: seals, back-up rings, plugs and packers, motor winding slot liners, protector thrust bearings, motor pot heads, compressor vanes, bearings and bushes, thrust washers, valve plates and high pressure hoses, downhole sensors, marine risers, subsea umbilicals, hoses and/or sheaths; and/or wherein said component is a back-up ring, wherein said back-up ring is preferably a split seal back-up ring.

31. The component according to claim 29, wherein said component is arranged to provide a precursor to any of the other components, and wherein said component comprises a tube and/or billet; and preferably, wherein the tube and/or billet has an outer diameter of at least 5 cm, but at most 30 cm.

32. An oil and/or gas installation or apparatus for use in relation to an oil and/or gas installation, said installation or apparatus comprising a component according to claim 29.

33. A process for manufacturing a component arranged to guide the flow of a fluid, restrict the flow of a fluid, facilitate movement between two parts, facilitate support of one or more parts and/or facilitate connection of two or more parts, and/or is arranged to provide a precursor to any of the other components above, the process comprising, in sequence:
a) selecting a composite material according to claim 1; and
b) forming said component via injection moulding, compression moulding and/or extruding said composite material.

34. The process according to claim 33, wherein step b) comprises forming said component via injection moulding, and wherein the process further comprises, after step b):
c) annealing said component.

35. The process according to claim 33, wherein the component is a tube and/or billet, and wherein said tube and/or billet is cut to provide one or more seal, back-up ring, bushing, and/or washer.

36. Use of a composite material according to claim 1 in the manufacture of a component to increase the flexural modulus, measured in accordance with ISO178 (80 mm×10 mm×4 mm specimen, tested in three-point-bend at 175° C. at a rate of 2 mm/minute), of said component, and/or to provide a flexural modulus of said component, measured in accordance with ISO178 (80 mm×10 mm×4 mm specimen, tested in three-point-bend at 175° C. at a rate of 2 mm/minute), of at least 0.45 GPa.

37. Use of a composite material according to claim 1 in the manufacture of a split seal back-up ring to reduce the spring of said split seal back-up ring, wherein the spring of said split seal back-up ring is determined by measuring an average gap or overlap as described in Example 8, and/or to provide a maximum average gap or overlap of 4 mm between the two ends of said split seal back-up ring.

38. Use of a composite material according to claim 1 in automotive, aerospace, medical, electronic, oil and/or gas applications.

39. Use of a component which comprises a composite material or an apparatus comprising said component in an oil and/or gas installation, wherein said composite material is according to claim 1.

40. Use of the composite material according to claim 1 in the manufacture of a compression moulded component to provide a Notched Izod Impact Strength (specimen 80 mm×10 mm×4 mm with a cut 0.25 mm notch (Type A), tested at 23° C., in accordance with ISO180) of said component of at least 12.5 kJm⁻² and a flexural modulus of said component, measured in accordance with ISO178 (80 mm×10 mm×4 mm specimen, tested in three-point-bend at 175° C. at a rate of 2 mm/minute), of at least 3.0 GPa.

41. A composite material comprising:
i) one or more polymeric material having a repeat unit of formula
—O-Ph-O-Ph-CO-Ph- I
wherein Ph represents a phenylene moiety; and
ii) one or more glass fibre;
wherein said one or more polymeric material has a melt viscosity (MV) of more than 0.15 kNsm⁻², but less than 0.65 kNsm⁻², measured according to Example 1;
wherein MV is the melt viscosity of said one or more polymeric material measured in kNsm⁻² and according to Example 1; and
wherein the composite material is in the form of a tube and/or billet, or a back-up ring, preferably a split seal back-up ring.

42. A component which comprises a composite material comprising:
i) one or more polymeric material having a repeat unit of formula
—O-Ph-O-Ph-CO-Ph- I
wherein Ph represents a phenylene moiety; and
ii) one or more glass fibre;
wherein said one or more polymeric material has a melt viscosity (MV) of more than 0.15 kNsm⁻², but less than 0.65 kNsm⁻², measured according to Example 1;
wherein MV is the melt viscosity of said one or more polymeric material measured in kNsm⁻² and according to Example 1; and
wherein said component is arranged to guide the flow of a fluid, restrict the flow of a fluid, facilitate movement between two parts, facilitate support of one or more parts and/or facilitate connection of two or more parts, and/or is arranged to provide a precursor to any of the other components above.

43. A tube and/or billet comprising a hollow cylinder having at least one closed end, wherein said hollow cylinder comprises a composite material according to claim 1, and wherein an edge between an external surface of said closed end and an external lateral surface of said cylinder comprises at least one curved portion.

44. The tube and/or billet according to claim 43, wherein said at least one curved portion at least partially extends around a circumference of said edge, preferably said at least one curved portion completely extends around a circumference of said edge.
